(19) United States
(12) Patent Application Publication
(10) Pub. No.: US 2006/0098745 A1
(43) Pub. Date: May 11, 2006

(54) APPARATUS AND METHOD FOR EVALUATING DATA TRANSMISSION

(76) Inventors: Yu-Pin Chou, Miao- Li Hsien (TW); Hsu-Jung Tung, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/164,065

(22) Filed: Nov. 9, 2005

(30) Foreign Application Priority Data
Nov. 9, 2004 (TW) 093134056

(51) Int. Cl. H04L 27/00

(52) U.S. Cl. 375/259

(57) ABSTRACT

The present invention discloses an apparatus for evaluating a transmission quality of data display system and its related method. The method comprises: mixing at least one pattern in a first signal of an image signal to produce a mixed signal in the transmitter, wherein said pattern is known to said receiver; transferring the mixed signal to the receiver through a channel; separating the received mixed signal into a received signal and a received pattern in the receiver; and evaluating the transmission quality of the display system according to the pattern and the received pattern.

### BACKGROUND OF THE INVENTION

1. Field of the Invention

The present invention relates to a display system, particularly to an apparatus for improving transmission quality of the display system.

2. Description of Related Art

Referring to FIG. 1 a schematic diagram of the architecture of a digital visual interface (DVI) specification, the DVI module 2 comprises a transmitter 10 and a receiver 30; the graphics controller 1 generates an image signal; the image signal is encoded by a Transmission Minimized Differential Signaling (TMDS) encoder 12 in the transmitter 10; then via TMDS channel 22 of a DVI interface 20, the encoded signals is transmitted to a decoder 32 in the receiver 30 for decoding; then the decoded signal is transferred to a display controller 3 of the display device, and thus the image signal coming from the graphics controller 1 becomes the images in the display device. When the display device is turned on, a Display Data Channel (DDC) master 14 of the transmitter 1 0 requires that the DDC slaver 34 of the receiver 30 provides an information of all support-modes (ex: 640×480 60Hz, 640×480 72Hz, 800×600 60Hz, 1024x768 60Hz, . . . , etc.), which the display device can support, through a DDC channel 24 of the DVI interface 20 to the transmitter 1 0 so that the graphics controller 1 can output appropriate format of the image signal to the display device.

However, in the progress of signal transmission between the transmitter 10 and the receiver 30, there are many variables, such as the impedance of the transmitter, the length of the transmission line, transmission speed, etc., making it hard for the receiver to receive all the data with the same setting value. Further, as the transferred data is an image data, the receiver 30 cannot know what kind of data is transferred from the transmitter 10 or whether the data received is correct, and thus the receiver 30 cannot optimum itself in response to the current state.

### SUMMARY OF THE INVENTION

The objective of the present invention is to provide an apparatus for improving quality of data transmission and related method to solve the above-mentioned problems.

Another objective of the present invention is to provide an apparatus for improving quality of data transmission and related method, wherein the data transmitted by the transmitter is embedded with a characteristic pattern that has been known to the receiver such that the receiver to be able to evaluate the quality of the data transmission.

Another objective of the present invention is to provide an apparatus for improving quality of data transmission and related method, wherein the receiver can evaluate the quality of the data transmission and appropriately adjust the parameter of the receiver.

Via the preferred embodiments described below in conjunction with the attached drawings, the objectives, technical contents, characteristics and accomplishments of the present invention are to be more easily understood.

### BRIEF DESCRIPTION OF THE DRAWINGS

FIG. 1 is a schematic diagram of the architecture of a DVI module.

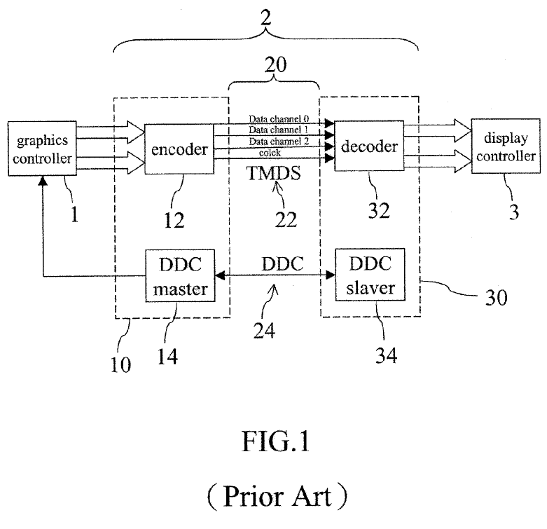

FIG. 2 is a schematic diagram of the architecture according to one embodiment of the present invention.

FIG. 3 is a flowchart of the method according to one embodiment of the present invention.

### THE PREFERRED EMBODIMENTS OF THE INVENTION

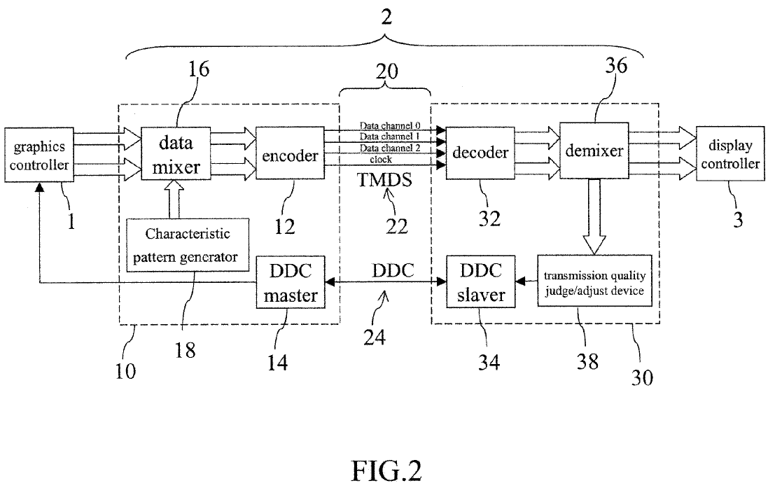

Refer to FIG. 2 the schematic diagram of the architecture according to one embodiment of the present invention. In this embodiment, a digital visual interface (DVI) 20 is disposed between a transmitter 10 and a receiver 30. The transmitter 10 comprises: an encoder 12, a DDC master 14, a data mixer 16, and a pattern generator 18. The receiver 30 comprises: a decoder 32, a DDC slaver 34, a demixer 36, and a decision/adjust circuit 38. In this embodiment, the data mixer 16 mixes the data from the graphics controller 1 and the predetermined pattern from the pattern generator 18 to create a mixed signal, which is sent to the encoder 12. The encoder 12 encodes the mixed signal; the encoded signal is then transferred through the TMDS channel 22 in the DVI 20 to the decoder 32 of the receiver 30 for decoding; after decoding, the demixer 36 separates the decoded mixed signal into received data and a received pattern, and the received data is transferred to the display controller 3 of the display device to enable the signal coming from the graphics controller 1 become the image on the display device; simultaneously, the demixer 36 sends the received pattern to the decision/adjust circuit 38 for evaluation to evaluate the transmission quality according to the received pattern, via which the parameters of the receiver 30 can be appropriately adjusted.

In another embodiment, if the decision/adjust circuit 38 regards the transmission quality as still inferior after the parameters of the receiver 30 have been modified, the receiver 30 will start a reset function. In the reset state, the DDC master 14 will ask that the DDC slaver 34 transfer the information of the support-modes of the display device except the current support-mode to the transmitter 10 via the DDC channel 24. The receiver 30 deletes the portion of the current support-mode (transmission mode of inferior quality) from the supported support-modes to enable the data to be transferred between the transmitter 10 and the receiver 30 in another support-mode.

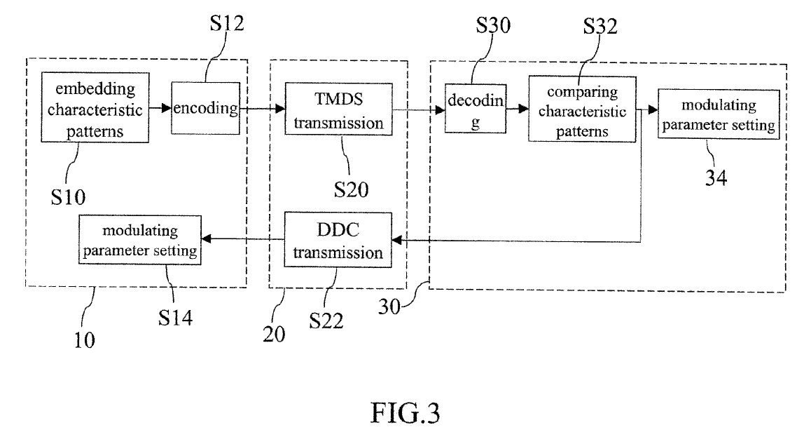

FIG. 3 is a flowchart of the method according to one embodiment of the present invention, and please refer to both FIG. 2 and FIG. 3. In step S10, the predetermined pattern is embedded into the data that is to be transmitted by the transmitter 10. In an embodiment of the present invention, the pattern includes a specific head and a pattern data or is embedded in an unexploited interval in the aforementioned data or consists of an undefined control bit in data format of the data of the corresponding standard. The data segment is utilized to carry the predetermined pattern, wherein the embedded predetermined pattern is transferred to the receiver 30, and the predetermined pattern known to the receiver 30 is pre-defined or transferred thereto via the DDC channel.

In step S12, the encoder 12 in the transmitter 10 encodes the aforementioned mixed data, and then the process proceeds to step S20; in step S20, the encoded data is sent to the receiver 30 through the TMDS channels 22, and then the process proceeds to step S30; in step S30, the encoded data is decoded by the decoder 32, and the predetermined pattern is extracted, and then the process proceeds to step S32; in step S32, the received pattern is compared with the known pattern to determine whether the reception is correct or not, and the correct reception means that the transmission quality of the TMDS channels 22 is well and the data received by the receiver 30 should be correct and it is needless to modulate the transmission parameters; if the reception is incorrect, the process proceeds to the next step S34; in step S34, the parameter of the receiver 30 is appropriately adjusted. The aforementioned predetermined pattern is embedded in the data which can be a control signal, an image data, or a data defined specifically otherwise.

In a preferred embodiment, according to the compare result of step S32, the receiver 30 undertakes step S22 to send a quality signal through the DDC channel 24 to the transmitter 10 in order to perform step S14 wherein the parameter of the transmitter 10 is modulated. In this preferred embodiment, the means of modulating the parameter of the transmitter 10 may be changing the amplitude of the data or changing the transmission speed (i.e. lowering the frequency) or both.

In the present invention, the predetermined pattern is embedded into the data sent out by the transmitter 10 to enable the receiver 30 to judge whether the current setting is well and evaluate the channel response in order to modulate the parameters and improve the quality of transmission; thus, even the signal influenced by the length of the impedance transmission line, transmission speed, etc., the receiver can be modulated to avoid the attenuation or distortion of the signal.

The embodiments described above are only to clarify the technical thoughts and characteristics of the present invention in order to enable the persons skilled in this art to be able to understand, make and use the present invention, and it is not intended to limit the scope of the present invention, and any equivalent modification and variation according to the spirit of the present invention disclosed herein is to be included within the scope of the present invention.

What is claimed is:

1. A display system for evaluating a transmission quality, comprising: a transmitter, comprising:
a pattern generator for generating a pattern; and
a data mixer, coupled to the pattern generator, for mixing a first signal of an image signal and the pattern to produce a mixed signal;
a channel, coupled to the transmitter, for transferring the mixed signal; and
a receiver, coupled to the channel, for receiving the mixed signal from the transmitter, the receiver comprising:
a demixer for separating the received mixed signal into a received signal and a received pattern; and
a decision circuit, coupled to the demixer, for determining the transmission quality according to the received pattern and the pattern.

2. The display system of claim 1, wherein said pattern comprises an undefined control bits in data format of said first signal.

3. The display system of claim 1, wherein said pattern is embedded in an unexploited interval of said first signal.

4. The display system of claim 1, wherein said pattern comprises a head and a pattern data.

5. The display system of claim 1, wherein said pattern known to said receiver is predefined.

6. The display system of claim 1, wherein said receiver receives said predetermined pattern via a display data channel (DDC) channel of the channel.

7. The display system of claim 1, wherein said first signal is a control signal or a data or a data defined specifically otherwise.

8. The display system of claim 1, wherein said received signal is transferred to a display controller of a display device.

9. The display system of claim 1, wherein said channel is a Transmission Minimized Differential Signaling (TMDS) channel.

10. The display system of claim 1, wherein the decision circuit adjusts a receiving parameter of the receiver according to the transmission quality.

11. The display system of claim 1, wherein the transmitter receivers the transmission quality via a digital display channel (DDC) channel and adjusts a transmission parameter of the transmitter according to the transmission quality.

12. A method for evaluating a transmission quality in a display system, which comprises a transmitter and a receiver, the method comprising:
mixing at least one pattern in a first signal of an image signal to produce a mixed signal in the transmitter, wherein said pattern is known to said receiver;
transferring the mixed signal to the receiver through a channel;
separating the received mixed signal into a received signal and a received pattern in the receiver; and
evaluating the transmission quality of the display system according to the pattern and the received pattern.

13. The method of claim 12, further comprising: adjusting a receiving parameter of said receiver according to said transmission quality.

14. The method of claim 12, wherein said pattern comprises an undefined control bits in data format of said first signal.

15. The method of claim 12, wherein said receiver receives the pattern via a display data channel (DDC) channel.

16. The method of claim 12, wherein said first signal is a control signal or a data or a data defined specifically otherwise.

17. The method of claim 12, wherein said channel is a Transmission Minimized Differential Signaling (TMDS) channel.

18. A transmitter located in a display system which evaluates a transmission quality between the transmitter and a receiver of the display system, the transmitter comprises:
a pattern generator for generating a pattern;
a mixer coupled to said pattern generator, for mixing a first signal of an image signal and said pattern to produce a mixed signal;
a first circuit, coupled to the mixer, for transmitting the mixed signal to the receiver through the channel;
a second circuit, coupled to the channel, for receiving the evaluated transmission quality produced by the receiver and adjusting a transmission parameter of the transmitter according to the evaluated transmission quality.

19. The transmitter of claim 18, wherein the second circuit receives the evaluated transmission quality produced by the receiver via a digital display channel (DDC) of the channel.

20. A receiver of a display system for evaluating a transmission quality, the receiver received an mixed signal generated by a transmitter through a channel, the mixed signal being mixed according to a first signal of an image signal and a pattern, the receiver comprising:
a demixer, coupled to said channel, for separating said received mixed signal into a received signal and a received pattern; and
a decision circuit, coupled to said demixer, for comparing said received pattern with the pattern to output a compare result and determining the transmission quality of the display system according to said compare result.
